(19) United States
(12) Patent Application Publication
(10) Pub. No.: US 2020/0061790 A1
(43) Pub. Date: Feb. 27, 2020

(54) FLYWHEEL-DRIVEN SETTING DEVICE

(71) Applicant: HILTI AKTIENGESELLSCHAFT, Schaan (LI)

(72) Inventors: Dominik SCHMIDT, Feldkirch (AT); Tilo DITTRICH, Feldkirch (AT); Raphael THON, Wiener Neustradt (AT)

(21) Appl. No.: 16/461,623

(22) PCT Filed: Nov. 9, 2017
(86) PCT No.: PCT/EP2017/078704

§ 371 Date: May 16, 2019

(30) Foreign Application Priority Data
Nov. 18, 2016 (EP) 16199458.7

(51) Int. Cl. B25C 1/06; B25C 5/15

(52) U.S. Cl. CPC B25C 1/06; B25C 1/008; B25C 5/15

(57) ABSTRACT

A flywheel-driven setting device comprises a flywheel which can be drivingly connected to a driving element in order for a setting element to be driven into a substrate by means of the driving element during a setting process. The flywheel is subdivided into at least two flywheel parts which are movable relative to each other to a limited degree in the axial direction.

### TECHNICAL FIELD

The present invention relates to a flywheel-driven setting device comprising a flywheel which can be drivingly connected to a driving element in order for a setting element to be driven into a substrate by means of the driving element during a setting process.

### PRIOR ART

A flywheel-driven setting device comprising a two-layer flywheel is known from the Taiwanese abstract TW 201134616 A. From US publications US 2009/0194573 A1 and US 2012/0097729 A1 flywheel-driven setting devices are known, in which the flywheel has V-grooves disposed in the peripheral direction, wherein a setting plunger of the setting device has V-shaped groove-counterparts.

### REPRESENTATION OF THE INVENTION

The object of the invention is to provide a flywheel-driven setting device with a flywheel, which is drivingly connectable with a driving element in order to drive a setting element into a substrate during a setting process with the driving element, which has a small wear during operation.

The object is achieved in a flywheel-driven setting device comprising a flywheel which can be drivingly connected to a driving element in order for a setting element to be driven into a substrate by means of the driving element during a setting process, in that the flywheel is subdivided into at least two flywheel parts which are movable relative to each other to a limited degree in the axial direction. The flywheel-driven setting device is preferably a hand-held setting device, which is also referred to as a setting tool. The setting elements or fastening elements are, for example, nails or bolts which are driven into the substrate with the aid of the setting device, which is also referred to as a setting device. The setting energy is advantageously provided by an electric motor and transmitted via the flywheel to the driving element, which is also referred to as setting plunger. For this purpose, the flywheel is rotated by the electric motor. The rotational energy of the flywheel is transmitted, for a setting process, to the driving element, in particular the setting plunger, which is also abbreviated as plunger. With the help of the driving element, in particular of the plunger, the fastening element is driven into the substrate. For transmitting the rotational energy from the flywheel to the driving element, the flywheel is initially connected, for example by means of a suitable coupling device, in a frictional engagement with the driving element. For this purpose, the driving element can be arranged between the flywheel and a counter-roller. The driving element can be made in one or more parts. The term axial refers to an axis of rotation of the flywheel. The term axial means in the direction or parallel to the axis of rotation of the flywheel. The flywheel may, for example, be divided into three or four flywheel parts. The flywheel parts are designed essentially as annular discs. It has been found in tests and analyses carried out in the context of the present invention that when using more than one V-groove, a fit between the flywheel and the driving element is over-constrained. This can lead to not all flank sides of the groove flanks of the V-grooves being simultaneously engaged in the friction pairing. This can lead to undesirably high wear on the driving element or on the flywheel, since less surface is available for the friction pairing. In addition, coupling efficiency varies over the life of the setting device as grinding and wear effects occur. Ultimately, this variation results in a variation of the setting energy and thus leads to an undesirable unpredictability of the setting quality during operation of the setting device. By dividing the flywheel in at least two flywheel parts, wear during the friction-fit between driving element and flywheel can be significantly reduced. In addition, the at least two flywheel parts enable a constant friction pairing between the driving element and the flywheel.

A preferred exemplary embodiment of the flywheel-driven setting device is characterized in that the flywheel parts each comprise at least one friction-fit geometry, which can be frictionally connected to a complementary friction-fit geometry of the driving element for forming a friction-fit between the flywheel and the driving element. By means of an axial movement of the flywheel parts relative to each other, manufacturing tolerances and wear of the friction pairing occurring during operation can be compensated. In addition, a constant power transmission over the entire life of the setting device is ensured in a simple manner.

A further preferred exemplary embodiment of the flywheel-driven setting device is characterized in that the friction-fit geometry comprises a substantially V-shaped groove which can be frictionally connected to a complementary counter-body of the driving element. The flywheel subdivided into several parts advantageously comprises a plurality of V-grooves. For example, at least three V-grooves can be used if the flywheel is composed of three flywheel parts. More V-grooves mean a larger coupling surface or frictional surface and thus less wear per coupling flank or groove flank. An undesirable over-constraining of the frictional engagement system is reliably prevented by the axial mobility of the flywheel parts relative to one another. As a result, the life of the setting device can be significantly extended. The complementary counter-bodies of the driving element, for example, have the shape of ribs with a substantially V-shaped rib cross-section.

Another preferred exemplary embodiment of the flywheel-driven setting device is characterized in that the flywheel parts are two halves of the flywheel. According to one embodiment, it has proven to be sufficient if the flywheel is divided exactly into two halves. As a result, a symmetrical load during operation of the flywheel is ensured in a simple manner.

A further preferred embodiment of the flywheel-driven setting device is characterized in that the flywheel parts are biased away from each other by at least one spring device. The flywheel parts are preferably axially biased away from each other by the spring device such that a small axial movement of the flywheel parts relative to one another is possible. As a result, the desired compensation of manufacturing tolerances during operation of the setting device can be ensured. The spring device is, for example, at least one disc spring.

Another preferred embodiment of the flywheel-driven setting device is characterized in that the flywheel parts, which are biased away from each other, are held together in the axial direction by a holding device. As a result, an undesired release of the flywheel parts from each other is ensured in a simple manner. The holding device is, for example, a collar sleeve with a collar, which represents a first axial abutment.

A second axial abutment is represented, for example, by a threaded nut, which is screwed onto an end of the collar sleeve facing away from the collar. Both flywheel parts are arranged, together with the spring device, which is arranged therebetween, between the two axial abutments of the holding device.

A further preferred embodiment of the flywheel-driven setting device is characterized in that the flywheel parts are connected to each other in a non-rotatable but axially movable way by means of coupling elements, in particular coupling pins. The coupling elements are advantageously distributed uniformly over a circumference of the flywheel parts. The coupling elements, in particular coupling pins, are advantageously accommodated or guided in corresponding recesses of the flywheel parts. The recesses may be designed as blind holes in the flywheel parts.

The above object is achieved alternatively or additionally in a flywheel-driven setting device comprising a flywheel, which can be drivingly connected to a driving element in order for a setting element to be driven into a substrate by means of the driving element during a setting process, in that the driving element is subdivided in at least two driving element parts, which are movable relative to each other to a limited degree in the axial direction. Each driving element part is advantageously provided with a complementary friction-fit geometry, in particular a complementary counter-body. The term axial refers to the axis of rotation of the flywheel. With the subdivided driving element, the same effect can advantageously be achieved as with the subdivided flywheel, which has been described above.

The above object is achieved alternatively or additionally in a flywheel-driven setting device comprising a flywheel, which can be drivingly connected to a driving element in order for a setting element to be driven into a substrate by means of the driving element during a setting process, in that the driving element comprises at least two complementary friction-fit geometries, which are movable relative to each other to a limited degree in the axial direction. The term axial also refers to the axis of rotation of the flywheel. The complementary frictional engagement geometries are preferably essentially V-shaped counter-bodies, as described above. The friction-fit geometries, in particular the V-shaped counter-body, for example, can be designed as inserts, which are movable to a limited degree relative to the driving element in the axial direction. The friction-fit geometries can be biased in the axial direction by means of spring devices.

The invention further relates to a flywheel, in particular a flywheel part, and/or a driving element, in particular a driving element part, for a previously described setting device. The parts mentioned may be handled separately.

Optionally the invention also relates to a method for operating a setting device as described above.

Further advantages, features and details of the invention will become apparent from the following description in which, with reference to the drawings, various embodiments are described in detail. In particular:

FIG. 1 is a simplified illustration of a flywheel-driven setting device comprising a flywheel which is spaced apart from a driving element before a coupling release;

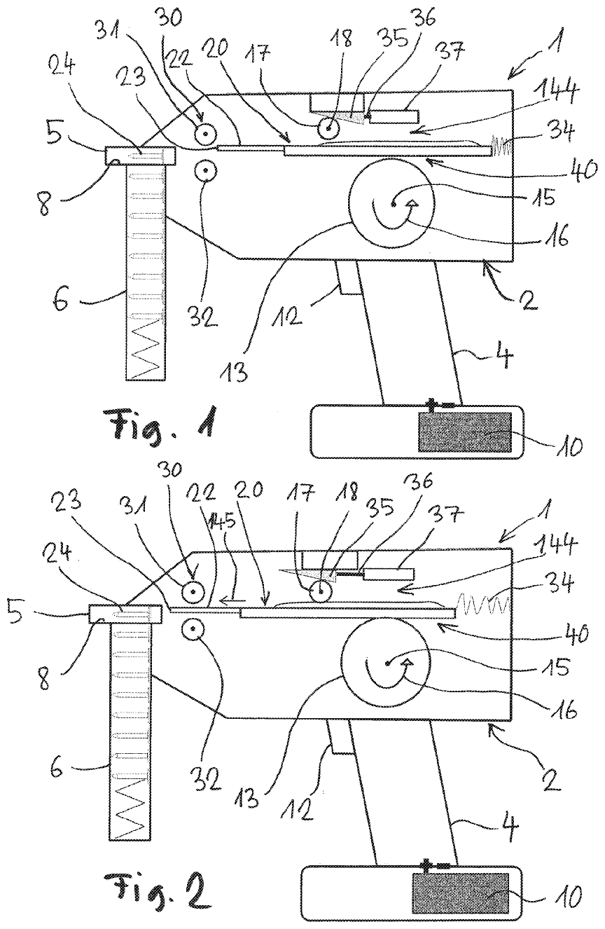

FIG. 2 shows the setting device of FIG. 1, wherein the driving element is frictionally connected to the flywheel;

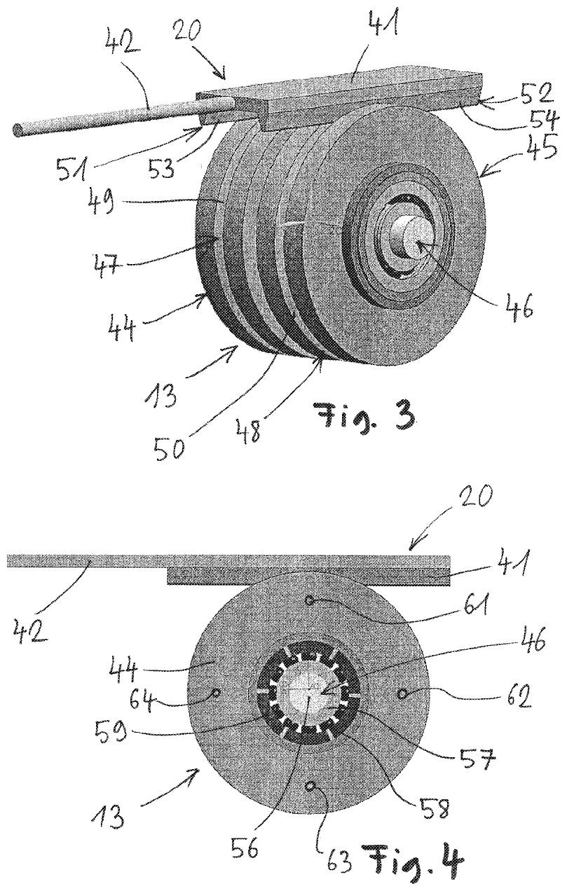

FIG. 3 is a perspective view of a subdivided flywheel with a driving element;

FIG. 4 is a cross-sectional view of the flywheel with the driving element of FIG. 3;

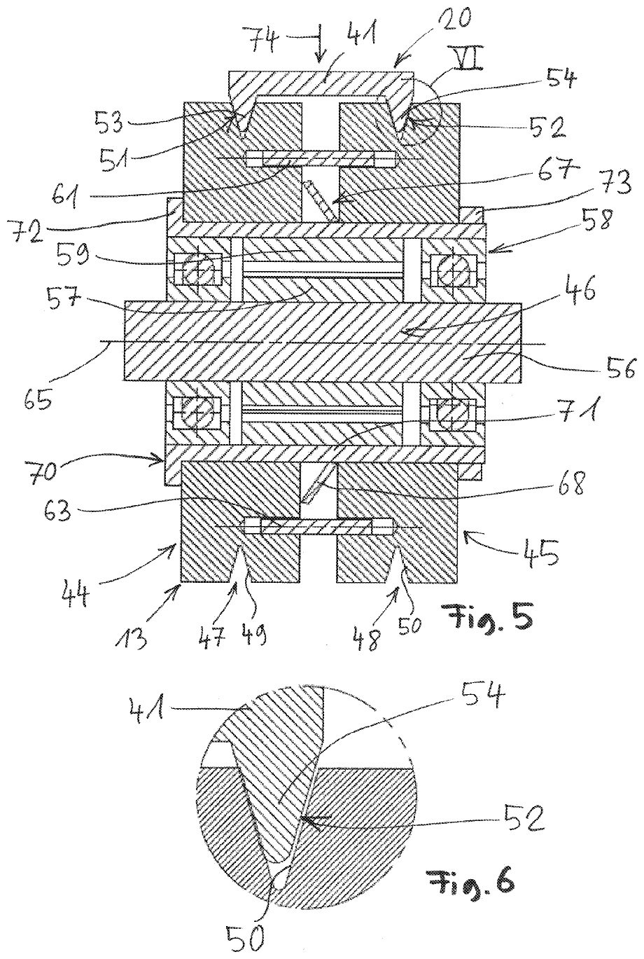

FIG. 5 is a view of a longitudinal section through the flywheel with the driving element from FIG. 3, wherein there are still fit errors;

FIG. 6 is an enlarged view of a detail VI of FIG. 5, illustrating a fit error;

FIG. 7 is the same sectional view as in FIG. 5, wherein the fitting errors are compensated;

FIG. 8 is an enlarged view of a detail VIII of FIG. 7 to illustrate the compensated fitting error and

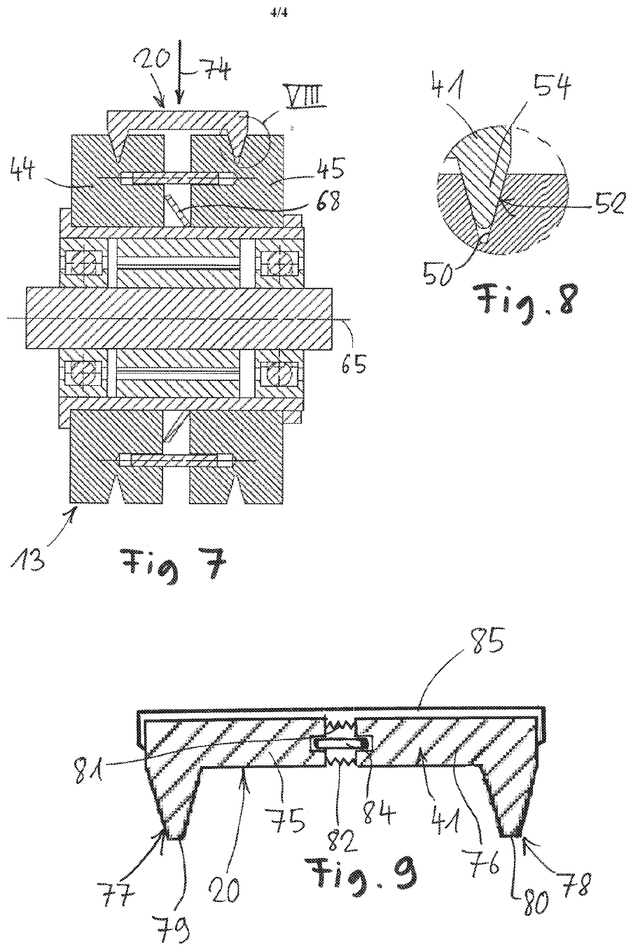

FIG. 9 shows a subdivided driving element in cross section.

### EXEMPLARY EMBODIMENTS

In FIGS. 1 and 2, a flywheel-driven setting device 1 comprising a housing 2 is shown in simplified form. The setting device 1 is designed as a hand-operated setting device with a handle 4 and a setting end 5.

The setting device or setting tool 1 is used for driving fastening elements 24 into a substrate (not shown). A desired number of fastening elements 24 is stored in a magazine 6 at the setting end 5. From the magazine 6, the fastening elements 24 are provided individually, preferably automatically, in a bolt guide 8.

The energy required for driving in the fastening elements 24 is provided, for example, in the form of electrical energy in an accumulator 10 at the lower end of the handle 4. The electrical energy stored in the accumulator 10 is converted into rotational energy by means of an electric motor (not shown), which is advantageously integrated in a flywheel 13.

By this rotational energy, the flywheel 13 is rotated about a flywheel rotation axis 15, as indicated by an arrow 16 in FIGS. 1 and 2. Upon actuation of a trigger or operating knob 12 on the handle 4, a coupling, which is integrated in the setting device 1 and which is designed, for example, as a helical-gear coupling, is closed such that the rotational energy stored in the flywheel 13 is transmitted as translational energy to a driving element 20 to initiate the setting process.

The driving element 20 represents a setting plunger 22, which is also indicated simply as a plunger. The setting plunger 22 or the driving element 20 are arranged between the flywheel 13 and a counter-roller 17.

The counter-roller 17 is rotatable about a counter-roller rotation axis 18, which is arranged parallel to the flywheel rotation axis 15. The counter-roller 17, together with the flywheel 13 and the driving element 20 arranged therebetween, constitute a coupling device 144 which, as will be explained below, is actuated via an electromagnet 37.

The setting plunger 22 has at its left end in FIGS. 1 and 2 a plunger tip 23, with which the fastening element 24 at the setting end 5 of the setting device 1 can be driven into the substrate (not shown). The setting plunger 22 or the driving element 20 are guided in the setting device 1 by means of at least one plunger guide 30 back and forth in the axial direction, to the left and to the right in FIGS. 1 and 2.

The plunger guide 30 comprises two guide rollers 31, 32. In order to drive in the fastening element 24, the setting plunger 22 is moved with its plunger tip 23 toward the fastening element 24 with great acceleration through the plunger guide 30. After a setting operation, the setting plunger 22 is moved back again, by means of a return spring 34, into its starting position, which is shown in FIGS. 1 and 2.

The coupling device 144 in the setting device 1 comprises a wedge 35, which is movable with a follower 36 by the electromagnet 37 in order to press the counter-roller 17 downwards in FIG. 1 against the driving element 20. In FIG. 1, the setting device 1 is shown before a coupling release.

FIG. 1 shows the setting device 1 immediately before a setting process. The flywheel 13 has been rotated, for example, by an integrated brushless electric motor and thus has an energy in the form of rotational energy, as indicated by the arrow 16 in FIG. 1.

In FIG. 2, the coupling device 144 is actuated via the electromagnet 37 so that the driving element is pressed by the counter-roller 17 downwards against the flywheel 13. As a result, a friction-fit between the flywheel 13 and the driving element 20 is produced in a connecting region 40.

The friction causes the rotational movement of the flywheel 13, indicated by the arrow 16, to be transmitted to the driving element 20, so that the latter is moved in a setting direction indicated by an arrow 145 in FIG. 2 to the left onto the fastening element 24 in the bolt guide 8. As soon as the driving element 20 strikes the fastening element 24 with the plunger tip 23, it is driven into the substrate at the setting end 5 of the setting device 1.

FIG. 3 shows a multi-part embodiment of the flywheel 13 comprising the driving element 20 in perspective. The driving element 20 comprises a connecting body 41 and a setting body 42. The setting body 42 represents a setting plunger with which a setting element or fastening element (24 in FIGS. 1 and 2) can be driven into a substrate.

The connecting body 41 is integrally connected to the setting body 42 in the illustrated embodiment. But the connection between the setting body 42 and the connecting body 41 can also be different, for example by means of a positive connection, in particular via a screw thread. The connecting body 41 serves for producing a friction-fit between the driving element 20 and the flywheel 13.

The flywheel 13 is subdivided into a flywheel part 44 and a flywheel part 45. In the illustrated embodiment, the flywheel parts 44, 45 represent two flywheel halves of the flywheel 13. The multi-part flywheel 13 is rotatably mounted on a fixed stator 46 of an electric motor which is integrated with the flywheel 13.

In order to improve the friction-fit between the flywheel 13 and the driving element 20, the flywheel parts 44, 45 of the flywheel 13 each have a friction-fit geometry 47, 48. The friction-fit geometries 47, 48 are designed as V-grooves 49, 50. A V-groove is defined as an annular groove, which has a V-shaped annular groove cross-section.

On the connecting body 41 of the driving element 20 complementary friction-fit geometries 51, 52 are formed. The complementary friction-fit geometries 51, 52 include counter-bodies 53, 54, which frictionally engage in the V-grooves 49, 50 of the flywheel 13.

The counter-bodies 53, 54 are configured as ribs with a V-shaped rib cross-section, which tapers into a point towards the flywheel 13. By the engagement of the counter-bodies 53, 54 in the V-grooves 49, 50, the effective friction surface for providing the frictional engagement between the flywheel 13 and the driving element 20 can be effectively increased.

In the sectional view shown in FIG. 4, it can be seen that the stator 46 comprises a stator shaft 56. On the stator shaft 56 coil windings of a coil 57 are fastened, which generate a changing or alternating magnetic field and cause a rotation of the flywheel 13 together or in interaction with permanent magnets 59. The stator shaft 56 is firmly anchored in a housing (not shown).

The flywheel parts 44, 45 of the flywheel 13 are rotatably supported relative to the stator shaft 56 and the coil 57 by means of ball bearings 58.

Circles 61 to 64 in FIG. 4 indicate coupling elements, which serve to connect the two flywheel parts 44, 45 non-rotatably but in an axially displaceable manner to each other. The term axial refers to a rotation axis of the flywheel 13.

In the longitudinal section through the stator shaft 56 shown in FIG. 5, the axis of rotation of the flywheel 13 is designated as 65. The sectional view shows that the flywheel parts 44, 45 of the flywheel 13 have the shape of circular annular disks with a rectangular ring cross section. A spring device 67 is clamped in the axial direction between the flywheel parts 44, 45. The spring device 67 in the illustrated embodiment comprises a disc spring 68.

A holding device 70 axially holds together the two flywheel parts 44, 45, which are biased away from each other by the disc spring 68. The holding device 70 is designed as a collar sleeve 71 with a collar 72, which represents a first axial abutment for the flywheel part 44 of the flywheel 13. On the end of the collar sleeve 71 facing away from the collar 72, a threaded nut 73 is screwed, which forms a second axial abutment for the flywheel part 45 of the flywheel 13.

In FIG. 5 it can be seen that the coupling elements 61 and 63 designed as coupling pins are received with their ends in recesses of the flywheel parts 44, 45 designed as blind holes. Between the coupling elements 61.63 and the flywheel parts 44, 45 there is sufficient clearance to allow axial displacement of the flywheel parts 44, 45 relative to each another. The same applies to the fitting connections between the flywheel parts 44, 45 and the collar sleeve 71.

FIG. 6 shows an enlarged detail VI from FIG. 5. In the enlarged illustration, it can be seen that a left flank of the counter-body 54 in FIG. 6 is frictionally connected to the associated groove flank of the V-groove 50. Between the right flank of the counter-body 54 of FIG. 6 and the associated groove flank of the V-groove 50 there is still a manufacturing-related clearance available.

The flywheel parts 44, 45, which are also referred to as flywheel disks, are non-rotatably connected via a key or a splined connection (not shown) with the collar sleeve 71, which is also referred to as an axial sleeve. As a result, the axial sleeve or collar sleeve 71 is coupled radially to the flywheel parts 44, 45 or flywheel halves. In addition, the two flywheel halves or flywheel parts 44, 45 are non-rotatably coupled via the coupling elements or coupling pins 61 to 64, which are also referred to as radial pins.

In the axial direction, the flywheel halves or flywheel parts 44, 45 can move or slide to a certain extent relative to one another. The flywheel part 44 is clamped in the axial direction between the collar 72 of the collar sleeve or axial sleeve 71 and the disc spring 68. The flywheel part or the flywheel half 45 is clamped in the axial direction between the disc spring 68 and the threaded nut 73.

In FIG. 5, a force indicated by an arrow 74, acting from above onto the driving element 20, is still too small, in order to perform a desired axial compensation, as can be seen in FIG. 6. As a result, not all flanks contribute to the friction-fit, which leads to unilateral and undesirably high wear.

In FIG. 7, a larger arrow 74 indicates that a greater force acts on the driving element 20 from above. Due to the higher force 74, a desired axial compensation occurs, wherein the disc spring 68 is compressed and one of the flywheel halves or flywheel parts 44, 45 is axially moved or displaced.

FIG. 8 shows an enlarged detail VIII of FIG. 7. In the enlarged view, it can be seen that the desired axial compensation leads to all flanks of the friction pairing between the counter-body 54 and the V-groove 50 abutting each other to form the friction-fit between the flywheel and the driving element, and thus wearing evenly.

FIG. 9 shows, with reference to a greatly simplified exemplary embodiment, that the driving element 20 can also be of a multi-part design, in order to enable a desired axial compensation during operation of the setting device. The driving element 20 is subdivided into two driving-element parts 75, 76, as can be seen in the cross section through the driving element 20 shown in FIG. 9.

The left driving element part 75 in FIG. 9 is provided with a complementary friction-fit geometry 77, which corresponds to the complementary friction geometry 51 of the exemplary embodiment shown in FIG. 5. Similarly, the driving element part 76 shown on the right in FIG. 9 is provided with a complementary friction-fit geometry 78, which corresponds to the complementary friction geometry 52 in FIG. 5. The complementary friction-fit geometries 77, 78 are designed as substantially V-shaped counter-bodies 79, 80.

The two driving element parts 75, 76 in the illustrated embodiment represent driving element halves. The two driving element halves 75, 76 are biased away from each other by two spring elements 81, 82. By means of a coupling element 84, which is designed as a coupling pin, the two driving element parts 75, 76 are guided in an axially displaceable way relative to each other. The term axial refers to the axis of rotation of the flywheel (13 in FIGS. 5 and 7) and means parallel to the axis of rotation of the flywheel.

A holding element 85 holds the two driving element parts 75, 76 together in the axial direction. The driving element 20 preferably comprises over its length at least two, in particular more than two, coupling elements 84 and holding elements 85. Depending on the embodiment, however, the holding element 85 can also extend over the entire or part of the length of the driving element 20. The same applies to the coupling element 84, which can also be designed as a substantially elongated plate.

1. A flywheel-driven setting device comprising a flywheel which can be drivingly connected to a driving element in order for a setting element to be driven into a substrate by the driving element during a setting process, wherein the flywheel is subdivided into at least two flywheel parts which are movable relative to each other in an axial direction.

2. The flywheel-driven setting device according to claim 1, wherein the at least two flywheel parts respectively comprise at least one friction-fit, geometry, which can be frictionally connected to a complementary friction-fit geometry of the driving element, for forming a friction-fit.

3. The flywheel-driven setting device according to claim 2, wherein the at least one friction-fit geometry comprises a substantially V-shaped, groove, which can be frictionally connected to a complementary counter-body of the driving element.

4. The flywheel-driven setting device according to claim 1, wherein the at least two flywheel parts are two halves of the flywheel.

5. The flywheel-driven setting device according to claim 1, wherein the at least two flywheel parts are biased away from each other by at least one spring device.

6. The flywheel-driven setting device according to claim 5, wherein the at least two flywheel parts, which are biased away from each other, are held together in an axial direction by a holding device.

7. The flywheel-driven setting device according to claim 1, wherein the at least two flywheel parts are connected to each other in a non-rotatable but axially movable way by coupling elements.

8. The flywheel-driven setting device according to claim 1, wherein the driving element is subdivided in at least two driving element parts, which are movable relative to each other in an axial direction.

9. The flywheel-driven setting device according to claim 1, wherein the driving element comprises at least two complementary friction-fit geometries, which are movable relative to each other in an axial direction.

10. A flywheel and/or driving element for the flywheel-driven setting device of claim 1.

11. The flywheel-driven setting device of claim 7, wherein the coupling elements comprise coupling pins.

12. The flywheel-driven setting device according to claim 2, wherein the at least two flywheel parts are two halves of the flywheel.

13. The flywheel-driven setting device according to claim 3, wherein the at least two flywheel parts are two halves of the flywheel.

14. The flywheel-driven setting device according to claim 2, wherein the at least two flywheel parts are biased away from each other by at least one spring device.

15. The flywheel-driven setting device according to claim 3, wherein the at least two flywheel parts are biased away from each other by at least one spring device.

16. The flywheel-driven setting device according to claim 4, wherein the at least two flywheel parts are biased away from each other by at least one spring device.

17. The flywheel-driven setting device according to claim 14, wherein the at least two flywheel parts, which are biased away from each other, are held together in an axial direction by a holding device.

18. The flywheel-driven setting device according to claim 15, wherein the at least two flywheel parts, which are biased away from each other, are held together in an axial direction by a holding device.

19. The flywheel-driven setting device according to claim 16, wherein the at least two flywheel parts, which are biased away from each other, are held together in an axial direction by a holding device.

20. The flywheel-driven setting device according to claim 2, wherein the at least two flywheel parts, which are biased away from each other, are held together in an axial direction by a holding device.
